(19) United States
(12) Patent Application Publication
(10) Pub. No.: US 2026/0359444 A1
(43) Pub. Date: Nov. 12, 2026

(54) METHOD AND SYSTEM FOR USING DEEP GENERATIVE MODELS TO PERFORM RISK MANAGEMENT RELATING TO NON-NORMAL DATA DISTRIBUTIONS

(71) Applicant: JPMorgan Chase Bank, N.A., New York, NY (US)

(72) Inventors: Yousef EL-LAHAM, Brooklyn, NY (US); Xinlong LI, Queens, NY (US); Chenlin XU, Queens, NY (US); Eric LIANG, New York, NY (US); Taosong HE, Warren, NJ (US); Svitlana VYETRENKO, Berkeley, CA (US)

(73) Assignee: JPMorgan Chase Bank, N.A., New York, NY (US)

(21) Appl. No.: 19/201,390

(22) Filed: May 7, 2025

(51) Int. Cl. G06F 21/57

(52) U.S. Cl. CPC G06F 21/577; G06F 2221/034

(57) ABSTRACT

Various methods and processes, apparatuses or systems, and media for leveraging generative artificial intelligence (AI) in risk management in relation to non-normal data distributions are disclosed. The method includes: training an AI model using historical data that relates to a performance of a set of instruments; receiving a set of weights that relates to the set of instruments; receiving a significance level value α that relates to the set of instruments; using the AI model to apply an algorithm in order to estimate a covariance matrix of outputs for the set of instruments based on α and the set of weights; and computing, for a predetermined time interval, an estimated variance of the set of instruments based on the estimated covariance matrix of outputs. The estimated variance and the significance level value α may then be used to compute an α-level value-at-risk (VaR) value for the predetermined time interval.

### TECHNICAL FIELD

This disclosure relates to methods and apparatuses for leveraging generative artificial intelligence in risk management in relation to non-normal data distributions.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Risk management is a crucial aspect of quantitative analysis. A fundamental challenge in risk management is the estimation of risk metrics. Historically, risk metrics like value-at-risk (VaR) and expected shortfall (ES) have been widely used to measure potential risks, allowing for more informed decision making and resource allocation. VaR estimation has been a cornerstone of risk management since the 1990s, with the RiskMetrics model becoming an industry standard. Three primary approaches to VaR estimation are historical simulation, the variance-covariance method, and Monte Carlo simulation. Each of these methods has limitations: historical simulation assumes past distributions reflect future risks; variance-covariance assumes asset returns are normally distributed, which fails to capture the fat-tailed behavior of aggregate data; and Monte Carlo simulation, while being the most flexible, can be too computationally intensive to implement in some practical settings. These limitations pose ongoing research challenges, particularly in capturing fat-tailed and skewed distributions and adapting to sudden distributional shifts.

Conventional approaches or methods face several challenges that limit their applicability to real-world deployment. In particular, under standard architecture and training settings, existing tools fail to accurately model heavy-tailed distributions. This limitation has inspired several research efforts, focusing on accurately capturing heavy-tails either by making modifications directly to the training data, modifying the input distribution of a model, or even designing novel neural network architectures that theoretically can capture heavy-tailed behavior.

### SUMMARY

The present disclosure, through one or more of its various aspects, embodiments, and/or specific features or sub-components, provides, among other features, various systems, servers, devices, methods, media, programs, and platforms for leveraging generative artificial intelligence in risk management in relation to non-normal data distributions.

According to an aspect of the present disclosure, a method for using artificial intelligence (AI) to manage risk is provided. The method may be implemented by at least one processor. The method may include: training a first AI model using first historical data that relates to a performance of a plurality of instruments; receiving a first set of weights within which each respective weight relates to a respective instrument included in the plurality of instruments; receiving a significance level value α that relates to the plurality of instruments; using the first AI model to apply a predetermined first algorithm in order to estimate a covariance matrix of outputs for the plurality of instruments based on the significance level value α and the first set of weights; and computing, for a predetermined first time interval, an estimated variance of the plurality of instruments based on the estimated covariance matrix of outputs.

The method may further include forecasting a respective volatility of each respective instrument during the predetermined first time interval by using a second AI model that is trained using the first historical data and provided with a predetermined smoothing factor value.

The method may further include using the estimated variance and the significance level value α to compute an α-level value-at-risk (VaR) value for the predetermined first time interval.

The method may further include using the estimated variance and the significance level value α to compute an α-level expected shortfall (ES) value for the predetermined first time interval.

The first AI model may include one from among a variational autoencoder (VAE) model, a Wasserstein generative adversarial network (W-GAN) model, and a denoising diffusion probabilistic model (DDPM).

The predetermined first algorithm may include one from among a historical simulation algorithm, a variance covariance algorithm, and a Monte Carlo Bootstrap (MCB) algorithm.

The predetermined first time interval may be equal to one day.

The method may further include updating the first historical data with additional data that relates to a predetermined number N of days immediately following the training; and retraining the first AI model N days after the first training by using the updated first historical data.

The updating of the first historical data may use one from among an expanding window, a non-overlapping sliding window, and a sliding/expanding window.

According to another embodiment, a computing apparatus for using AI to manage risk is provided. The computing apparatus includes a processor; a memory; and a communication interface coupled to each of the processor and the memory. The processor may be configured to: train a first AI model using first historical data that relates to a performance of a plurality of instruments; receive, via the communication interface, a first set of weights within which each respective weight relates to a respective instrument included in the plurality of instruments; receive, via the communication interface, a significance level value α that relates to the plurality of instruments; use the first AI model to apply a predetermined first algorithm in order to estimate a covariance matrix of outputs for the plurality of instruments based on the significance level value α and the first set of weights; and compute, for a predetermined first time interval, an estimated variance of the plurality of instruments based on the estimated covariance matrix of outputs.

The processor may be further configured to forecast a respective volatility of each respective instrument during the predetermined first time interval by using a second AI model that is trained using the first historical data and provided with a predetermined smoothing factor value.

The processor may be further configured to use the estimated variance and the significance level value α to compute an α-level VaR value for the predetermined first time interval.

The processor may be further configured to use the estimated variance and the significance level value α to compute an α-level ES value for the predetermined first time interval.

The first AI model may include one from among a VAE model, a W-GAN model, and a DDPM.

The predetermined first algorithm may include one from among a historical simulation algorithm, a variance covariance algorithm, and an MCB algorithm.

The predetermined first time interval may be equal to one day.

The processor may be further configured to update the first historical data with additional data that relates to a predetermined number N of days immediately following the training; and retrain the first AI model N days after the first training by using the updated first historical data.

The processor may be further configured to perform the updating of the first historical data by using one from among an expanding window, a non-overlapping sliding window, and a sliding/expanding window.

According to yet another embodiment, a non-transitory computer readable storage medium storing instructions for using artificial intelligence (AI) to manage risk is provided. The storage medium includes a set of executable code which, when executed by a processor, causes the processor to: train a first AI model using first historical data that relates to a performance of a plurality of instruments; receive a first set of weights within which each respective weight relates to a respective instrument included in the plurality of instruments; receive a significance level value α that relates to the plurality of instruments; use the first AI model to apply a predetermined first algorithm in order to estimate a covariance matrix of outputs for the plurality of instruments based on the significance level value α and the first set of weights; and compute, for a predetermined first time interval, an estimated variance of the plurality of instruments based on the estimated covariance matrix of outputs.

When executed, the executable code may further cause the processor to forecast a respective volatility of each respective instrument during the predetermined first time interval by using a second AI model that is trained using the first historical data and provided with a predetermined smoothing factor value.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for leveraging generative artificial intelligence in risk management, in accordance with an embodiment.

FIG. 2 illustrates an exemplary diagram of a network environment with a device for leveraging generative artificial intelligence in risk management, in accordance with an embodiment.

FIG. 3 illustrates a system diagram for implementing a method for leveraging generative artificial intelligence in risk management, in accordance with an embodiment.

FIG. 4 illustrates an exemplary flow chart of a process for leveraging generative artificial intelligence in risk management, in accordance with an embodiment.

FIG. 5 illustrates an architecture and conditional feature extraction for a decoder network for a variational autoencoder and a generator for a Wasserstein generative adversarial network, in accordance with an embodiment.

FIG. 6 illustrates an architecture and conditional feature extraction for a denoising diffusion probabilistic model, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method for leveraging generative artificial intelligence in risk management may improve security by increasing accuracy in measuring potential risks, thereby allowing for more informed decision making and capital allocation. The system or method may also reduce power consumption by implementing a less computationally intensive mechanism for measuring the potential risks. In particular, the system or method may achieve these improvements by: training an AI model using historical data that relates to a performance of a set of instruments; receiving a set of weights that relates to the set of instruments; receiving a significance level value α that relates to the set of instruments; using the AI model to apply an algorithm in order to estimate a covariance matrix of outputs for the set of instruments based on α and the set of weights; computing, for a predetermined time interval, an estimated variance of the set of instruments based on the estimated covariance matrix of outputs; and using the estimated variance and the significance level value α to compute an α-level value-at-risk (VaR) value for the predetermined time interval.

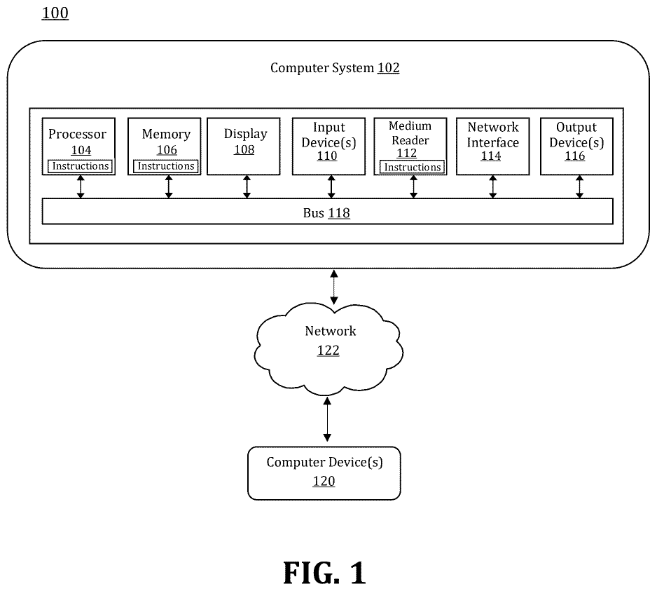

FIG. 1 is an exemplary system 100 for use in implementing a method for leveraging generative artificial intelligence in risk management across various types of instruments, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain′t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

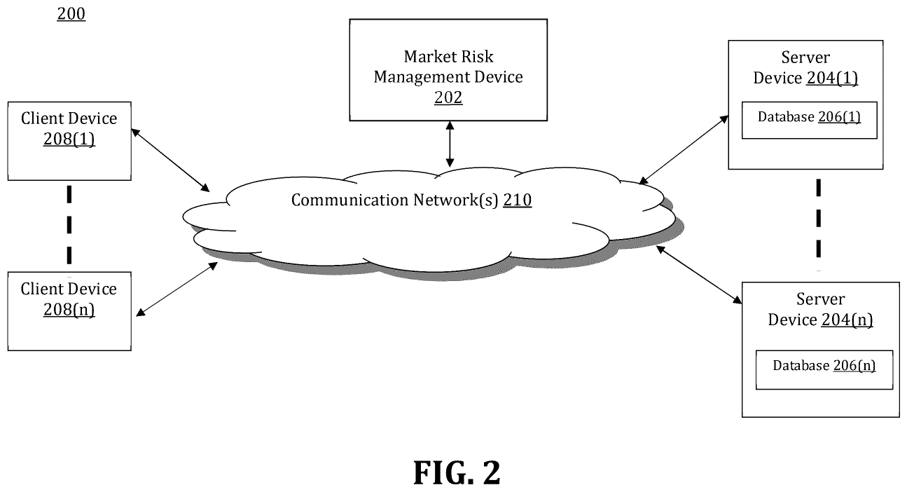

Referring to FIG. 2, a schematic of an exemplary network environment 200 for implementing a market risk management device (MRMD) of the instant disclosure is illustrated.

In some embodiments, the above-described problems associated with conventional tools may be overcome by implementing an MRMD 202 as illustrated in FIG. 2 that may be configured for implementing a method for leveraging generative artificial intelligence in risk management across various types of instruments, but the disclosure is not limited thereto.

The MRMD 202 may have one or more computer system 102s, as described with respect to FIG. 1, which in aggregate provide the necessary functions.

The MRMD 202 may store one or more applications that can include executable instructions that, when executed by the MRMD 202, cause the MRMD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MRMD 202 itself, may be located in virtual server(s) running in a cloud-based computing environment rather than being tied to one or more specific physical network computing devices. Also, the application(s) may be running in one or more virtual machines (VMs) executing on the MRMD 202. Additionally, in one or more embodiments of this technology, virtual machine(s) running on the MRMD 202 may be managed or supervised by a hypervisor.

In the network environment 200 of FIG. 2, the MRMD 202 is coupled to a plurality of server devices 204(1)-204(n) that hosts a plurality of databases 206(1)-206(n), and also to a plurality of client devices 208(1)-208(n) via communication network(s) 210. A communication interface of the MRMD 202, such as the network interface 114 of the computer system 102 of FIG. 1, operatively couples and communicates between the MRMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MRMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MRMD 202 may be a standalone device or integrated with one or more other devices or apparatuses, such as one or more of the server devices 204(1)-204(n), for example. In one particular example, the MRMD 202 may be hosted by one of the server devices 204(1)-204(n), and other arrangements are also possible. Moreover, one or more of the devices of the MRMD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MRMD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the MRMD 202 that may efficiently provide a platform for implementing a method for leveraging generative artificial intelligence in risk management across various types of instruments, but the disclosure is not limited thereto.

The client devices 208(1)-208(n) may run interface applications, such as standard web browsers or standalone client applications, which may provide an interface to communicate with the MRMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the MRMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the MRMD 202, the server devices 204(1)-204(n), or the client devices 208(1)-208(n), for example, may be configured to operate as virtual instances on the same physical machine. For example, one or more of the MRMD 202, the server devices 204(1)-204(n), or the client devices 208(1)-208(n) may operate on the same physical device rather than as separate devices communicating through communication network(s) 210. Additionally, there may be more or fewer MRMDs 202, server devices 204(1)-204(n), or client devices 208(1)-208(n) than illustrated in FIG. 2. In some embodiments, the MRMD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

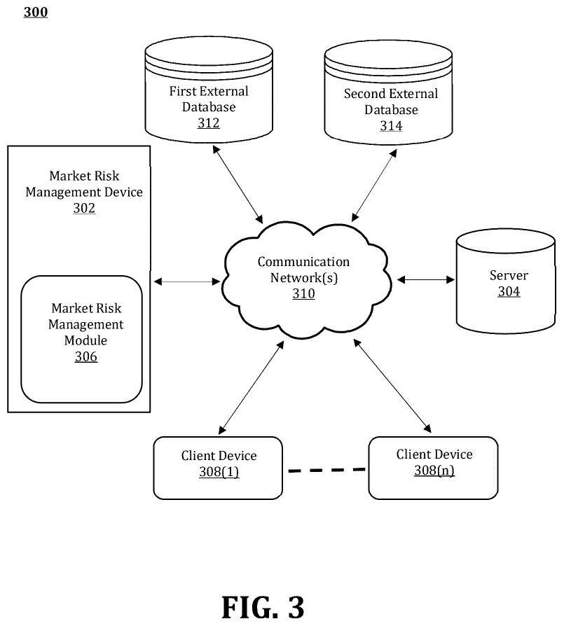

FIG. 3 illustrates a system diagram for implementing an MRMD 302 having a market risk management module (MRMM), in accordance with an embodiment.

As illustrated in FIG. 3, the system 300 may include an MRMD 302 within which an MRMM 306 is embedded, a server 304, a first external database 312, a second external database 314, a plurality of client devices 308(1) . . . 308(n), and a communication network 310.

In some embodiments, the MRMD 302 including the MRMM 306 may be connected to the server 304, and the database(s) 312 via the communication network 310. The MRMD 302 may also be connected to the plurality of client devices 308(1) . . . 308(n) via the communication network 310, but the disclosure is not limited thereto.

In an embodiment, the MRMD 302 is described and shown in FIG. 3 as including the MRMM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the MRMM 306 may be configured to receive real-time feed of data from the plurality of client devices 308(1) . . . 308(n) and secondary sources via the communication network 310.

As may be described below, the MRMM 306 may be configured to: train an AI model using historical data that relates to a performance of a set of instruments; receive a set of weights that relates to the set of instruments; receive a significance level value α that relates to the set of instruments; use the AI model to apply an algorithm in order to estimate a covariance matrix of outputs for the set of instruments based on α and the set of weights; compute, for a predetermined time interval, an estimated variance of the set of instruments based on the estimated covariance matrix of outputs; and use the estimated variance and the significance level value α to compute an α-level value-at-risk (VaR) value for the predetermined time interval, but the disclosure is not limited thereto.

The plurality of client devices 308(1) . . . 308(n) are illustrated as being in communication with the MRMD 302. In this regard, the plurality of client devices 308(1) . . . 308(n) may be “clients” (e.g., customers) of the MRMD 302 and are described herein as such. Nevertheless, it is to be known and understood that the plurality of client devices 308(1) . . . 308(n) need not necessarily be “clients” of the MRMD 302, or any entity described in association therewith herein. Any additional or alternative relationship may exist between either or both of the plurality of client devices 308(1) . . . 308(n) and the MRMD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the MRMD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The MRMD 302 may be the same or similar to the MRMD 202 as described with respect to FIG. 2, including any features or combination of features described with respect thereto.

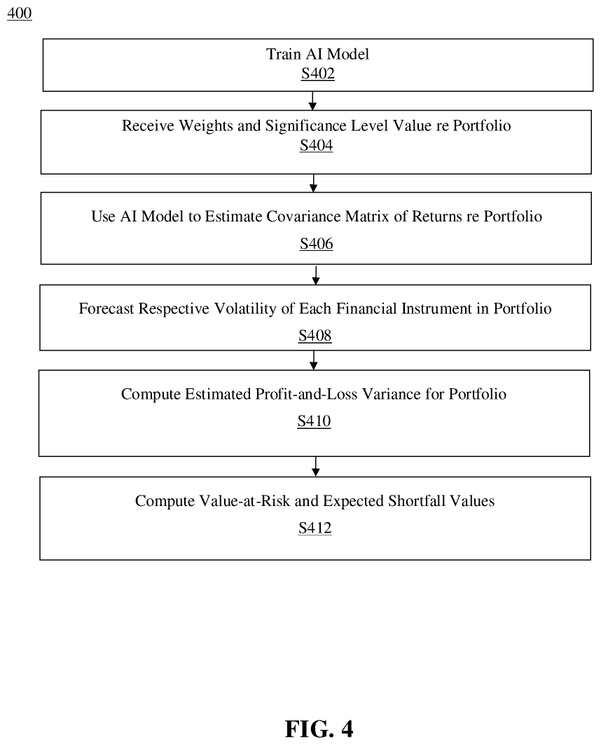

FIG. 4 illustrates an exemplary flow chart of a process 400 implemented by the MRMM 306 of FIG. 3 for enablement of a system and a method for leveraging generative artificial intelligence in risk management across various types of instruments, in accordance with an embodiment. It may be appreciated that the illustrated process 400 and associated steps may be performed in a different order, with illustrated steps omitted, with additional steps added, or with a combination of reordered, combined, omitted, or additional steps. In an embodiment, the risk management is manifested by the computation of non-parametric risk metric estimation and scenario generation of asset returns by using generative AI models, as further described below.

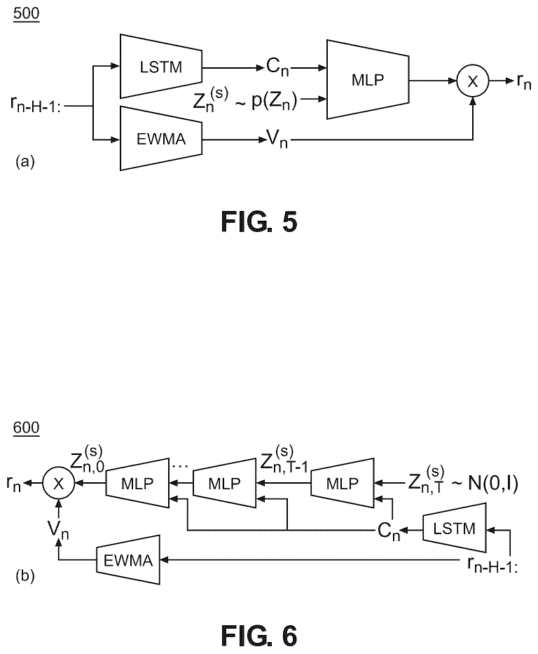

As illustrated in FIG. 4, at step S402, the process 400 may include training a first AI model using historical data that relates to a market performance of a financial portfolio that includes a plurality of instruments. In an embodiment, the plurality of instruments may include shares of stock, bonds, certificates of deposit, equities, futures, derivatives, and/or any other type of financial instrument. In an embodiment, the historical data may include data that relates to a price history and/or a value history of each instrument over a most recent predetermined interval of time, such as a most recent week, a most recent two-week period, a most recent month, a most recent six months, a most recent year, a most recent x number of years, and/or any other suitable interval of time. In an embodiment, Wasserstein generative adversarial network (W-GAN) models may be used; variational autoencoder (VAE) models may be used, and/or denoising diffusion probabilistic models (DDPMs) may be used; however, the present disclosure is not limited to these types of models, and various other types of generative models may also be used. In an embodiment, the training of the generative models is implemented by using historical data for which profit-and-loss results and corresponding value-at-risk results are known. Further description regarding the training of the models is provided below with respect to FIGS. 5 and 6.

At step S404, the process 400 may include receiving information that relates to a set of weights that relates to the financial portfolio and receiving a significance level value α that relates to the portfolio. In an embodiment, the information that relates to the set of weights may be received by the MRMM 306 from one or more network databases, such as the first external database 312 and/or the second external database 314. However, aspects of the present disclosure are not limited thereto, such that the information that relates to the set of weights may be acquired from one or more servers, such as the server 304, or client devices, such as any of client devices 308(1) to 308(n). In an embodiment, the significance level value α may refer to a probability value of rejecting the null hypothesis when it is true. For example, a significance level a of 0.10 indicates a 10% risk of concluding that a difference exists when there is no actual difference. In an embodiment, the set of weights includes a respective weight that is associated with a respective instrument that is included in the portfolio, such that there is a one-to-one correspondence between the plurality of instruments include in the portfolio and the set of weights. In an embodiment, the weights may correspond to a percentage value that the corresponding instruments represent within the portfolio, i.e., if Instrument Z represents 22% of the total value of the portfolio, then the weight that is associated with Instrument Z may be equal to 0.22.

At step S406, the process 400 may include using the trained first AI model to apply a predetermined algorithm in order to estimate a covariance matrix of returns for the financial portfolio based on the significance level value α and the set of weights. In an embodiment, a covariance matrix may refer to a square matrix that describes covariance between all pairs of variables in a dataset. The variables may include returns, significance level value α and the set of weights. The covariance matrix may indicate how much each variable changes together, providing insights into the relationship between them. In an embodiment, the covariance matrix of returns may be estimated using step 1 of the Algorithm 2: Variance Covariance, which is discussed in further detail below. In an embodiment, the first AI model may include any one of a variational autoencoder (VAE) model, a Wasserstein generative adversarial network (W-GAN) model, and/or a denoising diffusion probabilistic model (DDPM), but the present disclosure is not limited thereto, and other types of models may be employed. In an embodiment, the predetermined algorithm may include any one of a historical simulation algorithm, a variance-covariance algorithm, and/or a Monte Carlo Bootstrap (MCB) algorithm, but the present disclosure is not limited thereto, and other types of algorithms may be employed.

At step S408, the process 400 may include using the estimated covariance matrix of returns to compute an estimated profit-and-loss (PnL) variance of the financial portfolio for a predetermined time interval. In an embodiment, PnL variance may refer to a measure of dispersion, which indicates a measure of how far a set of values, such as PnL values, is spread out from their average value. In an embodiment, the PnL variance for the predetermined time interval may be estimated using step 2 of the Algorithm 2: Variance Covariance, which is discussed in further detail below. In an embodiment, the predetermined time interval may be one day, two days, one week, one month, and/or any other suitable time interval.

At step S410, the process 400 may include forecasting a respective volatility of each instrument included in the portfolio during the predetermined time interval. In an embodiment, volatility of an instrument may refer to a rate at which a value of the instrument increases or decreases over a particular period. In an embodiment, the PnL variance for the predetermined time interval may be estimated using step 3 of the Algorithm 2: Variance Covariance, which is discussed in further detail below. In an embodiment, a second AI model may be used to generate this forecast. The second AI model may be trained by using the same historical data, and a predetermined smoothing factor value may be provided as an input to the second AI model.

At step S412, the process 400 may include using the estimated PnL variance and the significance level value α to compute an α-level value-at-risk (VaR) value for the predetermined time interval and/or to compute an α-level expected shortfall (ES) value for the predetermined time interval. For example, if the predetermined time interval is equal to one day, then the VaR value for the portfolio and/or the ES value for the portfolio for the next day may be computed. Further description regarding the computation of the α-level VaR and ES values is provided below in reference to Expressions 3, 4 and 5.

In an embodiment, the process 400 may also include periodically retraining the first AI model and/or the second AI model so that the AI models regularly receive updated historical data, thus continually improving an accuracy of the outputs of the first AI model. For example, the historical data may be updated by using additional data that relates to a predetermined number N of days immediately following the most recent training of a particular AI model, and then retraining the particular AI model every N days. In an embodiment, N may be equal to 7 days, 14 days, 30 days, and/or any other suitable number of days. In an embodiment, the updating of the historical data may use any one of an expanding window, a non-overlapping sliding window, and/or a sliding/expanding window. For example, if N=14 days, then the expanding window may simply append 14 days worth of additional historical data to the original historical data set; the non-overlapping sliding window may replace the original historical data set with a new historical data set that includes the most recent 14 days of historical data; and the sliding/expanding window may delete some of the oldest historical data and append the most recent 14 days of historical data to the remaining data from the original set.

In an embodiment, a framework for incorporating generative artificial intelligence (GenAI) modeling in risk management is provided, with a particular focus on VaR estimation. In this aspect, a framework that leverages conditional deep generative models to create new market stress scenarios is disclosed. The framework is flexible, in the sense that it allows for arbitrary conditioning in the generative process. By learning from historical asset return distributions, this approach uncovers diverse tail scenarios beyond those observed in historical market data. The compatibility of this method with both implicit (e.g., GANs) and explicit (e.g., VAEs, DDPMs) generative models is demonstrated.

In an embodiment, the conditional deep generative models are employed for estimation of systematic risk metrics. In this approach, asset returns are generated from the generative model conditioned on a history window of past asset returns, and then used in a Monte Carlo simulation to compute the risk metrics. The strategy is improved by hybridizing the approach with an exponentially weighted moving average (EWMA) time-series model to improve robustness to volatility clustering.

In an embodiment, a comprehensive benchmark comparing classical approaches for risk metric estimation with that of the approach utilizing conditional generative models is provided. For the conditional generative models, three standard configurations of the most popular approaches are tested: VAEs, W-GANs, and DDPMs. Results of benchmark experiments, supported by standard performance metrics for value-at-risk (VaR) estimation, demonstrate that GenAI models obtain competitive or better performance than that of classical approaches.

In an embodiment, by utilizing both index and underliers returns in the conditional deep generative models, the idiosyncratic risk of assets can be simulated, and therefore the credit risk modeling may be broken down into systematic and idiosyncratic components.

In an embodiment, backtesting results on credit default swap (CDS) portfolios suggest that VaR utilizing a conditional generative model can capture not only systematic but also idiosyncratic risk, which leads to better performance.

In an embodiment, a goal is in the accurate estimation of portfolio risk metrics with the use of deep generative models. Consideration is given to a portfolio consisting of K assets. The return of the kth asset on day n, denoted by r_{k,n}, is defined as

$${r}_{k , n} = \frac{{P}_{k , n}}{{P}_{k , n - 1}} - 1 , \qquad ( Expression 1 ) ,$$

where p_{k,n} denotes the price of the kth asset on day n. The profit and loss (PnL) (profit is positive and loss is negative) of the portfolio on day n (in dollars), denoted by Xₙ, is the (weighted) average return (across the K underlying assets):

$${X}_{n} = {\sum }_{k = 1}^{K} {w}_{k , n} {r}_{k , n} , \qquad ( Expression 2 ) ,$$

where the weight w_{k,n} denotes the allocation (in dollars) of the kth asset. It is assumed that the relative weights are static in a given backtesting period; however, it is noted that the relative weights can be also be computed using some allocation strategy. In an embodiment, each weight w_{k,n} corresponds to a weight that is received as described above with respect to step S404 of FIG. 4, and each return r_{k,n} corresponds to an input for the PnL on day n, which corresponds to the computation of the estimated profit-and-loss variance as described above with respect to step S410 of FIG. 4.

Risk estimation amounts to predicting the VaR or the expected shortfall (ES) of the portfolio on a given day n. Let F_{Xn} (xₙ) denote the unknown cumulative distribution function (CDF) of the PnL on day n. The α-level VaR on a given day n, denoted by VaR α(Xₙ), is defined as the (1−α)-percentile of the loss Yₙ:=−Xₙ:

$${VaR}_{α} ( {X}_{n} ) = - inf \{ x ∈ R : {F}_{{X}_{n}} ( {x}_{n} ) > α \} \qquad ( Expression 3 )$$

$$= - {F}_{{X}_{n}}^{- 1} ( α ) = {F}_{{Y}_{n}}^{- 1} ( 1 - α ) \qquad ( Expression 4 )$$

The α-level ES on a given day n, denoted by ES α (Xₙ), is defined as the average VaR beyond the α-percentile of the loss distribution:

$${ES}_{α} ( {X}_{n} ) = - \frac{1}{α} {\int }_{0}^{α} {VaR}_{β} ( {X}_{n} ) d β \qquad ( Expression 5 )$$

Both VaR and ES correspond to properties of the PnL distribution. If the PnL distribution F_{Xn} is known, then both risk metrics can either be computed analytically or by numerical approximation (e.g., Monte Carlo simulation). However, the PnL distribution is unknown and so approximate methods have been developed for estimating VaR and ES. In an embodiment, the estimation of the VaR and/or the ES values as a property of the PnL distribution corresponds to the computation of VaR and/or the ES similarly as described above with respect to step S412 of FIG. 4.

Historical Simulation (HS) is a non-parametric approach for estimating VaR. HS estimates VaR by using the previous A historical asset returns to construct an empirical approximation to the cumulative distribution function (CDF) of the next day's PnL distribution. In mathematical terms, let r_{k,n}-h denote the historical return of the kth asset h days before day n. The historical PnL of each day may be computed as

$${x}_{n - h} = {\sum }_{k = 1}^{K} {w}_{k , n} {r}_{k , n - h} ,$$

and the following approximation to the PnL distribution may be formed:

$${F}_{{X}_{n}} ( {x}_{n} ) \approx {F}_{{X}_{n}}^{HS} ( {x}_{n} ) = \frac{1}{H} {\sum }_{h = 1}^{H} 1 ( {X}_{n} \leq {x}_{n - h} ) , \qquad ( Expression 6 )$$

where 1(⋅) denotes the indicator function. Let

$$( {\tilde{x}}_{n}^{( 1 )} , … , {\tilde{x}}_{n}^{( H )} )$$

denote the (ascending) sorted value of the historical PnLs (x_{n-H} . . . xₜ₋₁). The α-level VaR is defined to be the h_{α}th sample in sorted PnLs:

$${\text{?}}_{α}^{HS} ( {X}_{n} ) = - {\overline{x}}_{n}^{( {h}_{α} )} , \qquad ( Expression 7 )$$

where h_{α}=┌H(1−α)┐ for any α∈(0, 1). HS has a variety of benefits that make it a popular choice for estimating VaR: first, it does not make any distributional assumptions about the asset returns; second, it captures historical distribution of asset returns (e.g., dependence structure of the assets); and third, it is straightforward to compute and easy to interpret. HS also comes with several disadvantages: first, it is biased towards the history window, i.e., it assumes that patterns observed in the historical data will repeat in the future; second, it requires a large window size H to produce reliable estimators of the VaR; and third, it may capture tail risk if tails events are not present in the history window. Variations of HS have been proposed to improve on these pitfalls; such as weighted HS and filtered HS. In an embodiment, benchmarks are measured against the standard variation, which is summarized in Algorithm 1 below.

### Algorithm 1: Historical Simulation (HS)

Inputs: historical asset returns over period of size

$$H , {\{ {r}_{n - h} \}}_{h = 1}^{H} ;$$

significance level α; portfolio weights wₜ.
Step 1—compute PnL:

$${x}_{n - h} = {\sum }_{k = 1}^{K} {w}_{k , n} {r}_{n - h , k}$$

Step 2—output: Return (1−α)-level percentile of (−x_{n-H}, . . . , −xₙ₋₁).

Parametric Approach: As an alternative to HS, one approach for estimating VaR is to fit the asset returns to a parametric probability distribution. Consider a pdf p_{θ}(rₙ) with corresponding parameters θ∈Θ. The first step for calculating VaR using the parametric approach is to estimate the parameters based on the historical asset returns, with parameter estimates denoted by \hat{θ}, which can be obtained by maximum likelihood estimator (MLE), the method of moments (MOM) estimator, and maximum a posteriori (MAP) estimator. Once the parameters of the asset return distribution are estimated, a determination is made of the distribution of the PnL Xₙ, which is a linear transformation of the asset returns rₙ. Finally, the α-level VaR can be determined by finding the α-percentile of Xₙ using the inverse function of the approximated CDF.

A special case of this approach is the variance-covariance (VC) method for VaR estimation. The VC method assumes that the historical returns are distributed according to a multivariate Gaussian distribution:

rₙ~ [symbol] (rₙ:μᵣ_{ₙ}:Σᵣ_{ₙ}) (Expression 8),

where μᵣ_{ₙ} and Σrₙ denote the mean and covariance matrix of the asset returns, respectively. As a result, since the PnL Xₙ is a linear transformation of the asset returns rₙ, this parametric assumption implies that the PnL is also normally distributed. The covariance matrix Σrₙ is estimated using the sample covariance matrix:

$${\hat{Σ}}_{{r}_{n}} = \frac{1}{H - 1} {\sum }_{h = 1}^{H} ( {r}_{n - h} - {μ}_{{r}_{n}} ) {( {r}_{n - h} - {μ}_{{r}_{n}} )}^{⊤} , \qquad ( Expression 9 )$$

where rₙ−h denotes the asset return h days before day n and

$${μ}_{{r}_{n}} = \frac{1}{H} {\sum }_{h = 1}^{H} {r}_{n - h}$$

denotes sample mean of the historical returns. It is typically assumed that μᵣ_{ₙ}≈0. Once the covariance matrix of the asset returns is known, the PnL variance, denoted by

$${\hat{σ}}_{{x}_{n}}^{2} ,$$

can be determined as a linear transformation of \hat{Σ}ᵣ_{ₙ}:

$${\hat{σ}}_{{x}_{n}}^{2} = {w}_{n}^{⊤} {\hat{Σ}}_{{r}_{n}} {w}_{n} = {\sum }_{j = 1}^{K} {\sum }_{k = 1}^{K} {w}_{j , n} {w}_{k , n} \text{?} ( {r}_{j , n} , {r}_{k , n} ) , \qquad ( Expression 10 )$$

where wₙ=(w_{l,n}, . . . , w_{K,n}) denotes the vector of asset weights and [symbol] (r_{j,n}·r_{k,n}) denotes the estimated covariance between the jth and kth assets. Finally, the α-level VaR can be computed analytically directly using the standard deviation of the PnL \hat{σ}ₓ_{ₙ}:

$${\text{?}}_{α}^{VC} ( {X}_{n} ) = - {\hat{σ}}_{{x}_{n}} {F}_{Z}^{- 1} ( α ) , \qquad ( Expression 11 )$$

where F_{Z}⁻¹ (⋅) is the inverse function of a standard normal CDF.

The VC method offers several advantages over HS: first, the VaR estimate can be obtained analytically, which can be useful for performing sensitivity analysis and/or for decomposing risk factors; second, it provides smoother estimates of VaR even with a small history window; third, it provides a framework for handling new assets, for example, by fitting the parametric model to a pool of proxy assets; and fourth, it provides the flexibility for fitting more complex time-series models, which can improve the VaR estimates in periods of volatility clustering. However, parametric methods have significant limitations. They require explicit assumptions about return distributions, which can be problematic. The VC method assumes VaR is a linear combination of return covariances. This assumption often fails during market stress, as linear dependence measures like correlation tend to break down in extreme conditions, exposing a fundamental weakness in these approaches. In an embodiment, benchmarks are measured against two variations of the VC method: a standard implementation; and one that uses an exponentially-weighted moving average (EWMA) model to account for volatility clustering. Both implementations are summarized in a single algorithm table in Algorithm 2 below.

### Algorithm 2: Variance Covariance (VC and VC-EWMA)

Inputs: historical asset returns over period of size H,

$${\{ {r}_{n - h} \}}_{h = 1}^{H} ;$$

significance level α; portfolio weights, wₙ; EWMA smoothing factor, λ.
Step 1: Estimate covariance matrix of asset returns: Use the sample covariance matrix in Expression 9 to estimate \hat{Σ}ᵣ_{ₙ}. In an embodiment, step 1 corresponds to step S406 of FIG. 4.
Step 2 (optional): Estimate asset volatilities with EWMA(λ): For each asset k, fit an EWMA model to the historical returns and predict the volatility on day n, with v_{k,n} denoting the estimated volatility of the kth asset and vₙ=[v_{1,n}, . . . , v_{K,n}]^{T} denoting the vector of all volatilities. Modify covariance matrix estimate as: \tilde{Σ}ᵣ_{ₙ}=diag(vₙ)Cᵣ_{ₙ}diag(vₙ), where Cᵣₙ denotes the correlation matrix of the assets. In an embodiment, step 2 corresponds to step S408 of FIG. 4.
Step 3: Estimate PnL variance: Compute PnL variance

$${\hat{σ}}_{{x}_{n}}^{2}$$

using Expression 10 based on either \hat{Σ}ᵣ_{ₙ} or \tilde{Σ}ᵣ_{ₙ}. In an embodiment, step 3 corresponds to step S410 of FIG. 4.
Step 4: Output: Return −σₓₙF_{Z}⁻¹(α).

The following is a discussion of the Monte Carlo simulation approach for VaR estimation. The idea of Monte Carlo simulation is as follows: first, a probability model is chosen to model the returns. The model can be a non-parametric model, for example, one possible choice is the empirical distribution of the returns in the period of interest:

$${r}_{n} \sim \hat{p} ( {r}_{n} ) = \frac{1}{H} {\sum }_{h = 1}^{H} {δ}_{{r}_{n - h}} , \qquad ( Expression 12 )$$

where δᵣ_{ₙ₋ₕ} denotes a Dirac-delta function centered at rₜ₋ₙ. The probability model can also be a parametric model, rₙ~p_{\hat{θ}(r}ₙ), where \hat{θ} denotes an estimator of the underlying parameters of the probability model θ. Once a probability model is chosen and all necessary parameters are estimated, the probability model is used to simulate S scenarios:

$${r}_{n}^{( s )} \sim {p}_{\hat{θ}} ( {r}_{n} ) , s = 1 , … , S \qquad ( Expression 13 )$$

After the scenarios are generated, the corresponding PnL is computed for each generated scenario:

$${x}_{n}^{( s 〉} = {\sum }_{k = 1}^{K} {w}_{k , n} {r}_{k , n}^{( s )} , s = 1 , … , S , \qquad ( Expression 14 )$$

and sorted as

$$( {\overline{x}}_{t}^{( 1 )} , … , {\overline{x}}_{t}^{( S )} ) .$$

The α-level VaR is then

$${\text{?}}_{α}^{MC} ( {X}_{n} ) = - {\overline{x}}_{n}^{( {s}_{α} )} , \qquad ( Expression 15 )$$

where s_{α}=┌S(1−α)┐. The Monte Carlo simulation method for VaR estimation offers the benefits of both the HS method and the parametric method. First, it is flexible, in that both non-parametric and parametric models can be used to generate scenarios. Furthermore, the assumed model can be of any complexity; as long as one can simulate the desired returns, an estimate of VaR can be obtained, i.e., it is not limited to parametric assumptions that yield an exact analytical expression for VaR like the VC method. Second, it is robust to the size of the history window, in the sense that, in theory, one could generate a large number of scenarios to obtain smoother estimates of the VaR. Third, new assets can be handled by simulating returns through proxy assets or other techniques. The drawback of the Monte Carlo simulation method is its computational complexity; mainly, the methodology requires fitting potentially complex parametric models, generating scenarios, and revaluing the portfolio based on the generated scenarios. Additionally, the approach is less interpretable than both the HS approach, which can be viewed as evaluating VaR under the assumption that historical patterns will repeat, and the VC method, which explicitly expresses the dependence on VaR on the underlying asset covariances.

There are numerous ways to utilize the Monte Carlo simulation approach for VaR estimation, that mainly differ based on the choice of probability model for representing the scenarios. In an embodiment, benchmarks are measured against one variation of Monte Carlo simulation, where the stochastic model is the empirical distribution of the historical data. This approach is referred to herein as the Monte Carlo bootstrap (MCB) approach and it is summarized in Algorithm 3 below.

### Algorithm 3: Monte Carlo Bootstrap (MCB)

Inputs: historical asset returns over period of size H,

$${\{ {r}_{n - h} \}}_{h = 1}^{H} ;$$

significance level α; portfolio weights wₙ
Step 1—Generate scenarios: Bootstrap S samples, i.e., sample with replacement, from the historical asset return distribution, i.e.,

$${r}_{n}^{( s )} ∼ \frac{1}{H} {\sum }_{h = 1}^{H} {δ}_{{r}_{n - h}} ,$$

for s=1, . . . , S.
Step 2—Compute PnL:

$${x}_{n}^{( s )} = {\sum }_{k = 1}^{K} {w}_{k , n} {r}_{k , n}^{( s )}$$

Step 3—Output: Return (1−α)-level percentile of

$$( - {x}_{t}^{( 1 )} , … , - {x}_{t}^{( S )} ) .$$

In an embodiment, the use of conditional deep generative models is contemplated in order to capture the probability distribution of the underlying assets in a given portfolio, which is used in a Monte Carlo simulation for VaR estimation. Three state-of-the-art generative models are evaluated: VAEs, W-GANs, and DDPMs. It is noted that other types of deep generative models can be used, including normalizing flows (NFs) and energy-based models (EBMs), and/or any other suitable type of generative model. The following provides a discussion of a practical implementation that leads to an adoption of the generative models for VaR estimation, and a discussion of other potential applications of GenAI within the risk management framework, including capturing idiosyncratic risk in credit default swap (CDS) portfolios and generation of stress scenarios.

Deep Generative Modeling of Asset Returns: For each day n that VaR is to be estimated, consideration is given to a historical dataset over a window of H days of underlying asset returns and a corresponding set of conditional variables, denoted by

$${𝒟}_{n} = {\{ ( {r}_{n}^{( h )} , {c}_{n}^{( h )} ) \}}_{h = 1}^{H} ,$$

where

$${r}_{n}^{( n )} := {r}_{n - h}$$

denotes the historical return h days before day n and

$${c}_{n}^{( h )} ϵ 𝒞$$

denotes a conditional variable associated with the return

$${r}_{n}^{( h )} .$$

In practice, the conditional variable can be any auxiliary information to be used in the modeling of the return distribution. For example,

$${c}_{n}^{( h )}$$

could be chosen to be the sub-window of asset returns of size τ<H, i.e.,

$${c}_{n}^{( h )} := [ {r}_{n - h - 1} , … , {r}_{n - h - τ} ] ϵ {ℝ}^{K \times τ} .$$

The fundamental modeling assumption that is made is that given the conditional variables, the historical asset returns in the window are independent and identically distributed samples of the asset returns on day n:

$${r}_{n}^{( h} \vert {c}_{n}^{( h ) i . {i . d}_{∼}} \cdot {p}_{θ} ( {r}_{n} \vert {c}_{n}^{( h )} ) , h = 1 , … , H , \qquad ( Expression 16 )$$

where p_{θ}(rₙ|cₙ)p_{θ}(rₙ|cₙ) denotes a probabilistic model relating the conditioning variable to the asset returns. The following discussion relates to how to model this distribution with VAEs, W-GANs, and DDPMs. Each of the models is discussed in the context of conditional generation.

Variational Autoencoders: VAEs are an explicit generative model that utilize variational inference for model training. For a given training example (rₙ,cₙ), VAEs leverage the following lower-bound on the logarithm of the marginal likelihood of the asset returns (given the conditioning variables) called the evidence lower-bound (ELBO):

log p_{θ}(rₙ|cₙ)≥Σ(rₙ,cₙ;θ,φ) (Expression 17)

[symbol]

− [symbol] _{KL}(q_{φ}(zₙ|xₙ,cₙ)∥p(zₙ))+ [symbol] _{q}_{_{φ}}[ log p_{θ}(rₙ|zₙ,cₙ)] (Expression 18),

where p(zₙ) denotes a standard Gaussian prior on a latent variable zₙ, q_{φ}(zₙ|xₙ,cₙ) is a variational approximation of the posterior distribution p(zₙ|xₙ,cₙ), and [symbol] _{KL}(⋅∥⋅) denotes the Kullback-Leibler (KL) divergence. The variational approximation q_{φ} is typically assumed to belong to the family of diagonal Gaussian distributions, where the parameters φ correspond to the means and variances of each component of the latent variable. The choice of a diagonal Gaussian is convenient, since the KL divergence between two multivariate Gaussian distributions can be analytically computed. In the VAE framework, an encoder neural network g_{φ}: [symbol] ^{K}×C→ [symbol] ^{2×d}^{_{z}} is used to map a return and conditional variable pair (rₙ,cₙ) to the corresponding parameters of its variational approximation. A decoder network h_{θ}: [symbol] ^{d}^{_{z}}→ [symbol] ^{K} is used to map the latent random variable zₙ (conditioned on cₙ) to the corresponding return rₙ. Typically, VAEs are trained in via amortized inference, whereby all data samples share the same encoder and hence, the parameters are optimized to minimize the average ELBO:

$$\{ {ϕ}^{︵} , {θ}^{︵} \} = {arg max}_{ϕ ∈ Φ , θ ∈ Θ} \frac{1}{N} {\sum }_{h = 1}^{H} ε ( {r}_{n}^{( h )} , {c}_{n}^{( h )} ; θ , ϕ )$$

Wasserstein Generative Adversarial Networks. Generative adversarial networks (GANs) are a class of generative models trained via an adversarial training procedure. Here, GANs are discussed in the context of the W-GAN variation. There are two neural network models involved in W-GANs: a generator g_{θ}(zₙ,cₙ) with parameters θ∈Θ, which transforms a noise sample zₙ to a data sample rₙ; and a critic ƒ_{φ}(rₙ,cₙ) with parameters φ∈Φ, which assigns a real-valued score to a given sample rₙ. The goal of the generator is to generate samples that come from the same distribution as training data. The W-GAN achieves this goal by formulating GAN training as a minimization the Wasserstein distance between the data distribution and the distribution of the generative model. Under the assumption that the critic ƒ_{φ} is Lipschitz smooth, the Wasserstein distance between the training data and the generated data is proportional to b

$${max}_{ϕ ∈ Φ} {𝔼}_{( {r}_{n ,} {c}_{n} ) ∼ {𝒟}_{n}} [ {f}_{ϕ} ( {r}_{n} , {c}_{n} ) ] - {𝔼}_{{{z}_{n} ∼ p ( {z}_{n} )}_{{c}_{n} ∼ {𝒟}_{n}}} [ {f}_{ϕ} ( {g}_{θ} ( {z}_{n} , {c}_{n} ) ) ] . \qquad ( Expression 19 )$$

Hence, by minimizing Expression 19 with respect to θ, a generator can be trained to learn the underlying distribution of the observed data. This expression of the Wasserstein distance is only valid if the critic function ƒ_{φ} is Lipschitz smooth, which is practically ensured by either weight clipping or by adding a gradient penalty to the critic loss during training. Another important practical detail is that to stabilize training of the W-GAN, the critic, which is responsible for evaluating the Wasserstein distance, needs to be relatively accurate. In practice, J gradient steps are taken to improve the critic before a gradient step is taken to improve the generator. In an embodiment, an update frequency of J=5 may be used.

Denoising Diffusion Probabilistic Models: DDPMs are explicit deep generative models comprised of two processes: a forward diffusion process that corrupts the original data sample rₙ into standard Gaussian noise zₙ, and a reverse diffusion process which, given a condition cₙ, denoises random Gaussian noise zₙ~N(0, I) to a sample rₙ from the data distribution. Theoretically speaking, the dynamics of both the forward and reverse processes are mathematically described by stochastic differential equations (SDEs) defined over an infinite time horizon; in practice, the SDE that describes each process is discretized and defined over a fixed horizon T.

In particular, let r_{n,0}:=rₙ denote a sample from the unknown data distribution. The forward diffusion process corrupts the sample by iteratively applying Gaussian noise to the sample via:

q(r_{n,t}|r_{n,t-1})= [symbol] (r_{n,t};\sqrt{1−βₜ}r_{n,t},βₜI),t=1,2, . . . ,T (Expression 20),

where 0<β₁<β₂< . . . <β_{T}<1 denotes a fixed decay schedule. It is well-known that at T→∞, the limiting random variable r_{n,T} converges in distribution to a zero-mean multivariate Gaussian distribution with identity covariance matrix. An important property of the forward diffusion is that the distribution at any time-step t given r_{n,0}, can be determined analytically:

q(r_{n,t}|r_{n,0})= [symbol] (r_{n,t};\sqrt{\tilde{α}ₜ}r_{n,0},(1−\tilde{α}ₜ)I) (Expression 21),

where

$${\overline{α}}_{t} = {\prod }_{{t}^{′} = 1}^{t} ( 1 - {α}_{{t}^{′}} )$$

with αₜ:=(1−βₜ).

The reverse diffusion process is assumed to be driven by a parameterized probability (Gaussian) distribution, whose parameters are modeled by a neural network that depend on the time-step in the diffusion t and on the conditioning variable cₙ:

p_{θ}(r_{n,t-1}|r_{n,t},cₙ)= [symbol] (r_{n,t-1};ƒ_{θ}(r_{n,t},cₙ,t),g_{θ}(r_{n,t},cₙt)I) (Expression 22),

where ƒ_{θ} and g_{θ} denote the time-varying mean and variances of the reverse process. The goal of a DDPM is to optimize the parameters of the reverse diffusion process to recover the distribution of the training data.

FIG. 5 illustrates an architecture and conditional feature extraction for a decoder network for a variational autoencoder and a generator for a Wasserstein generative adversarial network 500, in accordance with an embodiment. FIG. 6 illustrates an architecture and conditional feature extraction for a denoising diffusion probabilistic model 600, in accordance with an embodiment.

Referring to FIG. 5 and FIG. 6, in an embodiment, a framework for VaR estimation utilizes one of the aforementioned deep generative models as a simulator in a Monte Carlo simulation.

Decoder: In an embodiment, a standard fully connected neural network (i.e., multi-layer perceptron or MLP) may be used for the decoding in the VAE/W-GAN models and for the denoiser in the DDPM.

Time-Series Feature Extraction: In an embodiment, to capture time-dependent properties of the underlying asset return distribution, a long-short-term-memory (LSTM) network may be utilized to map the conditioning time-series r_{n-h-τ:n-h-1}∈ [symbol] ^{K×τ} to a conditional feature vector cₙ∈ [symbol] ^{d}^{_{c}}. The extracted features are used as the conditional feature in all generative models, parameterizing the encoder/decoder in the VAE, the generator/critic in the W-GAN, and the reverse process Gaussian kernel in the DDPM. Importantly, this feature extraction allows for a compression of the information about historical time-series a feature of size d_{c}, which helps circumvent the difficulty in training conditional deep generative models, which are prone to overfitting. In an embodiment, the time-series feature extraction functionality uses historical data as inputs for purposes of training the generative model, similarly as described above with respect to step S402 of FIG. 4, and then, when the generative model has been trained, the time-series feature extraction functionality uses current data to estimate a covariance matrix of returns, similarly as described above with respect to step S406 of FIG. 4.

Hybridization with EWMA Model: In an embodiment, to effectively account for volatility clustering, the deep generative models may be hybridized with an EWMA model for effective learning. The EWMA model may be used as a means to introduce an inductive bias in the neural network architectures, since it takes care of capturing the time-varying volatility in the historical returns. In an embodiment, the capturing of the volatility is performed with respect to the historical data for purposes of training the generative model, similarly as described above with respect to step S402 of FIG. 4, and then, when the generative model has been trained, the EWMA model is used to forecast volatility with respect to the current data, similarly as described above with respect to step S408 of FIG. 4. For the VAE and W-GAN models, the predicted volatility is multiplied by the output of the decoder network, while in the DDPM, the final sample in the diffusion process is multiplied by the predicted volatility. In an embodiment, these multiplication operations generate results that correspond to the estimated returns of particular instruments on a particular day, and these returns are directly related to the profit-and-loss variance of those particular instruments, similarly as described above with respect to step S410 of FIG. 4.

The following is a discussion of important practical considerations related to training of the deep generative models.

Sliding vs. Expanding Window: When performing a backtest, an important consideration is the manner in which the models are updated with new information. In an embodiment, both the sliding window and expanding window approaches for updating the generative models may be used over the course of the backtest period. Empirically, it has been found that the expanding window approach is generally more effective, due to the fact that in most cases, training generative models requires copious amounts of data. In an embodiment, the training data window may be expanded every γ=14 days.

Hyperparameter Tuning: To appropriately select the hyperparameters for each model, an appropriate performance metric must be defined. In an embodiment, for the purpose of VaR estimation, two properties may be important to capture: similarity to historical distribution; and tail behavior. Thus, one suitable performance metric for hyperparameter tuning is a modified Kolomogorov-Smirnov statistic that takes into account the kurtosis of the data. Let [symbol] ₙ denote a synthetic dataset generated from one of the deep generative models. The modified Kolomogorov-Smirnov statistic may be defined as

$${KS}^{mod} ( {𝒟}_{n} , {\hat{𝒟}}_{n} ) = \frac{KS ( {𝒟}_{n} , {\hat{𝒟}}_{n} )}{1 ( {κ}_{syn} > {κ}_{real} )} , \qquad ( Expression 23 )$$

where KS( [symbol] ₙ, [symbol] ₙ) denotes the Kolomogovor-Smirnov statistic, and κᵣₑₐₗ and κ_{syn} denote the kurtosis of [symbol] ₙ and [symbol] ₙ, respectively. Minimizing the above performance metric selects a set of hyperparameters that would produce the closest approximation to the observed data distribution, while also guaranteeing a larger kurtosis in the synthetic data than that of the observed data.

The following is a discussion of potential applications beyond estimation of systematic VaR. For example, one potential application is the estimation of the idiosyncratic component of risk. For this application, one can condition on the return of an index to generate the idiosyncratic returns (i.e., the asset return subtracted by the index return). Another potential application is the generation of hypothetical stress scenarios. In this application, one can condition on a set of risk factors and shock them in order to stressed returns, thereby allowing for backtesting on adverse market conditions not encountered in historical data.

In some embodiments as disclosed above in FIGS. 1-6, technical improvements effected by the instant disclosure may include a platform for implementing a market risk control management module configured for enablement of leveraging generative artificial intelligence in risk management across various types of instruments, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for using artificial intelligence (AI) to manage risk, the method being implemented by at least one processor, the method comprising:
training a first AI model using first historical data that relates to a performance of a plurality of instruments;
receiving a first set of weights within which each respective weight relates to a respective instrument included in the plurality of instruments;
receiving a significance level value α that relates to the plurality of instruments;
using the first AI model to apply a predetermined first algorithm in order to estimate a covariance matrix of outputs for the plurality of instruments based on the significance level value α and the first set of weights; and
computing, for a predetermined first time interval, an estimated variance of the plurality of instruments based on the estimated covariance matrix of outputs.

2. The method of claim 1, further comprising forecasting a respective volatility of each respective instrument during the predetermined first time interval by using a second AI model that is trained using the first historical data and provided with a predetermined smoothing factor value.

3. The method of claim 1, further comprising using the estimated variance and the significance level value α to compute an α-level value-at-risk (VaR) value for the predetermined first time interval.

4. The method of claim 1, further comprising using the estimated variance and the significance level value α to compute an α-level expected shortfall (ES) value for the predetermined first time interval.

5. The method of claim 1, wherein the first AI model includes one from among a variational autoencoder (VAE) model, a Wasserstein generative adversarial network (W-GAN) model, and a denoising diffusion probabilistic model (DDPM).

6. The method of claim 1, wherein the predetermined first algorithm includes one from among a historical simulation algorithm, a variance covariance algorithm, and a Monte Carlo Bootstrap (MCB) algorithm.

7. The method of claim 1, wherein the predetermined first time interval is equal to one day.

8. The method of claim 1, further comprising updating the first historical data with additional data that relates to a predetermined number N of days immediately following the training; and retraining the first AI model N days after the first training by using the updated first historical data.

9. The method of claim 8, wherein the updating of the first historical data uses one from among an expanding window, a non-overlapping sliding window, and a sliding/expanding window.

10. A computing apparatus for using artificial intelligence (AI) to manage risk, the computing apparatus comprising:
a processor;
a memory; and
a communication interface coupled to each of the processor and the memory,
wherein the processor is configured to:
train a first AI model using first historical data that relates to a performance of a plurality of instruments;
receive, via the communication interface, a first set of weights within which each respective weight relates to a respective instrument included in the plurality of instruments;
receive, via the communication interface, a significance level value α that relates to the plurality of instruments;
use the first AI model to apply a predetermined first algorithm in order to estimate a covariance matrix of outputs for the plurality of instruments based on the significance level value α and the first set of weights; and
compute, for a predetermined first time interval, an estimated variance of the plurality of instruments based on the estimated covariance matrix of outputs.

11. The computing apparatus of claim 10, wherein the processor is further configured to forecast a respective volatility of each respective instrument during the predetermined first time interval by using a second AI model that is trained using the first historical data and provided with a predetermined smoothing factor value.

12. The computing apparatus of claim 10, wherein the processor is further configured to use the estimated variance and the significance level value α to compute an α-level value-at-risk (VaR) value for the predetermined first time interval.

13. The computing apparatus of claim 10, wherein the processor is further configured to use the estimated variance and the significance level value α to compute an α-level expected shortfall (ES) value for the predetermined first time interval.

14. The computing apparatus of claim 10, wherein the first AI model includes one from among a variational autoencoder (VAE) model, a Wasserstein generative adversarial network (W-GAN) model, and a denoising diffusion probabilistic model (DDPM).

15. The computing apparatus of claim 10, wherein the predetermined first algorithm includes one from among a historical simulation algorithm, a variance covariance algorithm, and a Monte Carlo Bootstrap (MCB) algorithm.

16. The computing apparatus of claim 10, wherein the predetermined first time interval is equal to one day.

17. The computing apparatus of claim 10, wherein the processor is further configured to update the first historical data with additional data that relates to a predetermined number N of days immediately following the training; and retrain the first AI model N days after the first training by using the updated first historical data.

18. The computing apparatus of claim 17, wherein the processor is further configured to perform the updating of the first historical data by using one from among an expanding window, a non-overlapping sliding window, and a sliding/expanding window.

19. A non-transitory computer readable storage medium storing instructions for using artificial intelligence (AI) to manage risk, the storage medium comprising executable code which, when executed by a processor, causes the processor to:
train a first AI model using first historical data that relates to a performance of a plurality of instruments;
receive a first set of weights within which each respective weight relates to a respective instrument included in the plurality of instruments;
receive a significance level value α that relates to the plurality of instruments;
use the first AI model to apply a predetermined first algorithm in order to estimate a covariance matrix of outputs for the plurality of instruments based on the significance level value α and the first set of weights; and
compute, for a predetermined first time interval, an estimated variance of the plurality of instruments based on the estimated covariance matrix of outputs.

20. The storage medium of claim 19, wherein when executed, the executable code further causes the processor to forecast a respective volatility of each respective instrument during the predetermined first time interval by using a second AI model that is trained using the first historical data and provided with a predetermined smoothing factor value.
